(19) United States
(12) Patent Application Publication
(10) Pub. No.: US 2026/0167349 A1
(43) Pub. Date: Jun. 18, 2026

(54) METHOD FOR DETERMINING THE COURSE AND/OR POSITION OF AN OUTER SURFACE OF AN AIRCRAFT RELATIVE TO AN ACCESS OR FEED DEVICE, AND AN ACCESS OR FEED DEVICE THAT CAN BE OPERATED USING SUCH A METHOD

(71) Applicant: HÜBNER GmbH & Co. KG, Kassel (DE)

(72) Inventors: Dirk W. Keßler, Vellmar (DE); Frederik Franz, Kassel (DE)

(73) Assignee: HÜBNER GmbH & Co. KG, Kassel (DE)

(21) Appl. No.: 19/421,834

(22) Filed: Dec. 16, 2025

(30) Foreign Application Priority Data
Dec. 16, 2024 (EP) 24220157.2

(51) Int. Cl. B64F 1/305; B63B 79/10; G05D 3/12

(52) U.S. Cl. CPC B64F 1/305; B63B 79/10; G05D 3/12

(57) ABSTRACT

A method for determining a position of an outer surface of a floating transport or flying transport relative to an access or supply device using a measuring device arranged on the access or supply device. The method includes defining a measuring region in which the outer surface is expected to be located or which the outer surface is expected to pass through, defining at least one reference segment which is located in the measuring region or passes through the measuring region, emitting the waves in such a manner that the waves capture the measuring region, receiving the reflected part of the emitted waves, generating a point cloud that maps the profile of the outer surface using the received reflected part of the emitted waves, determining at least one intersection point where the point cloud and the reference segment intersect, and determining the position of the intersection point.

### CROSS-REFERENCE TO RELATED APPLICATIONS

This application claims priority to European Patent Application No. 24220157.2 filed Dec. 16, 2024. The disclosure of the above-identified application, including the specification, drawings, and claims, is incorporated by reference herein in its entirety.

### TECHNICAL FIELD

The present disclosure relates to a method for determining the course/profile of an outer surface of an aircraft and/or for determining the position of the outer surface relative to an access or feed/supply device. Furthermore, the device relates to an access or feed/supply device which can be operated using such a method.

### BACKGROUND

Most major airports with modern terminal buildings use access devices that are predominantly designed as enclosed gangways. Passenger boarding bridges are permanently attached to the gate, but can be moved in two or three dimensions, so that they can be moved up to the boarding doors of the aircraft, hereinafter referred to as aircraft doors. These access devices allow passengers to board the aircraft directly; they do not enter the apron during boarding. Access devices have the further aspects that passengers can enter the aircraft directly, quickly, without steps, and free from weather influences.

A further design of access devices is the passenger stairs, which lead from the apron up to the aircraft doors. Passenger stairs are used primarily for financial reasons.

Feed or supply devices serve not only for the entry and exit of passengers, but also for loading or unloading items such as luggage or the like. Supply devices can be designed, for example, as baggage conveyor belts or as pallet trucks for containers or for catering vehicles.

The present disclosure is described below using aircraft as an example, but the following description applies equally to other types of transport, in particular flying transports, and also, for example, floating transport such as ships. The floating transport is located on a water surface instead of on the ground, and is always included in the scope of the present disclosure, even if flight-related vocabulary is used.

The present disclosure is described below using access devices, but the following description applies equally to supply devices. This comprises, in particular but not exclusively, the last module of the larger access component group closest to the aircraft, through which a person or object can enter the aircraft interior. The access device has a free end pointing towards the aircraft, typically with a circumferential bellows-like folding canopy, in particular made of a flat, ring-shaped rubber or silicone component that conforms to the given aircraft surface.

The access device can comprise various components, such as stairs, covered cabins, platforms, railings, doors, pendulum floors, or other elements that facilitate access. It may also have mechanisms to adapt to different heights or positions of the aircraft fuselage.

Access devices often need to be adjusted vertically or horizontally during operation. Most access devices are mounted on a rotatable and adjustable chassis, allowing for three-dimensional movement. They can be adjusted in the x, y and z directions to accommodate different aircraft types and the resulting different positions of the aircraft doors. In this context, movement in the x-direction represents the movement in the direction of travel of the access device, i.e., a forward or backward movement, while movement in the z-direction represents the vertical movement and movement in the y-direction the horizontal movement.

Horizontal adjustment is made when the access device slowly approaches an aircraft, while vertical adjustment is also important during loading and unloading, particularly due to the changing weight in the aircraft.

If the change in position of the aircraft fuselage relative to ground level exceeds a certain degree, the position of the access device must also be adjusted. As already described, this can be the case, for example, due to the loading and unloading of the aircraft in question, for example in a vertical direction. This adjustment is not necessary if the change in height is small. The height difference between the walkable floor of the access device and the aircraft door can be approximately half a meter without adjustment after a loading or unloading operation. The safety risk increases with increasing height difference.

In addition to this adjustment in height, it is particularly important to adjust the access device to the aircraft door when the aircraft slowly approaches the access device, i.e., when connecting the aircraft to the access device; therefore, the access device should also be automatically regulated in the x and y directions.

Access devices are known the position of which is manually adjusted to the aircraft door, which changes in the x and/or y and/or z direction, or to other prominent points of the aircraft geometry. In the past, adjustments were mostly made manually and electronically by a bridge operator who moved the component with a joystick.

It is known from, among others, FR 2 573 724 A1, to equip an access device with optoelectronic means that can detect a change in the position of the aircraft door relative to the approaching access device and initiate a corrective movement.

The FR 2 573 724 A1 also discloses a mechanical component, namely a so-called autoleveler, which has a rubberized measuring body in the shape of a wheel or roller that belongs to the access device and can be applied to the aircraft fuselage. This measuring body is located at the free end of a swivel arm and features a coding plate and various proximity switches. Based on rotations, a length measurement can be carried out, which allows the vertical displacement of the aircraft to be sensed and the bridge to be readjusted. The non-contact sensor technology of the autoleveler brings with it a number of disadvantages; in particular, the aircraft skin can be damaged by impact when the measuring body docks, which is especially the case with carbon fuselages. Furthermore, the problem arises that the autoleveler does not work equally well under all weather conditions, as slippage can occur on the measuring body when the aircraft fuselage is damp or icy, which distorts the measured values. Even in the event of a sudden drop in the aircraft's position, it is not always guaranteed that the measuring device will actually roll along the fuselage—and may rather perform a sliding or skidding motion. During sliding or slipping movements, none of the proximity switches of the measuring body may be activated, meaning that the control unit of the positioning drive of the access device does not receive a corresponding signal to lower or raise. Therefore, there is even a risk that the aircraft, with its door swung outwards, will touch the bottom of the access device, resulting in damage to both.

It is known to provide, in addition to the autoleveler, a so-called safety shoe, which is positioned between the floor of the access device on the one hand and the lower edge of the aircraft door on the other. If pressure is exerted on the safety shoe by the aircraft door, the safety shoe, in its function as a contact switch, also ensures that the access device is lowered by sending a corresponding signal to the control unit of the positioning drive. The safety shoe is necessary to initiate a rapid lowering of the access device in the event of a sudden, possibly jerky, descent of the aircraft. The safety shoe must be manually positioned below the open door of the aircraft for each boarding.

In addition, various non-contact instruments already exist for adjusting the access device in a vertical or horizontal direction:

EP 3 560 840 A1 describes a safety device with a non-contact proximity sensor, which serves to detect changes in the vertical distance of the access device to the aircraft door in a time-resolved manner and is located directly in the access device below the walkable top surface of the access device.

EP 3 088 305 A1 discloses a positioning method on the aircraft fuselage with at least two multi-channel scanners, in which a reference position of the access device is used in the docked state, the current position of the aircraft fuselage relative to the access device is determined at certain time intervals and, if a deviation is detected, a signal is transmitted by a computer unit to the controller of the positioning drive for adjustment of the access device.

A movable access device for an aircraft with a scanner arranged on the access device is mentioned in DE 10 2011 101 418 A1, wherein the scanner determines the position of the aircraft relative to the access device.

The patent applications EP 3 908 521 A1 and EP 3 760 547 A1 also disclose a platform that can be adjusted in height and/or in the x and y directions by an adjustment device. In the technical solution presented in EP 3 908 521 A1, the sensor technology used operates using marking devices. As the aircraft is raised or lowered, a camera captures how the markings projected onto the aircraft's outer surface by a laser move. The markings thus provide a necessary reference against which the change in height can be specified relatively.

It is disadvantageous to arrange the sensors close to the ground, as in EP 3 760 547A1 . When installed close to the ground, the sensors are not only exposed to weather conditions, but can also be damaged by people, machines and vehicles moving on the apron for handling purposes. Furthermore, the sensors pose additional risks to people, machines and vehicles. In addition to the safety risks and damage, the measurement itself can also be more easily disrupted in a ground-level arrangement.

In addition to insufficient protection against weather, precipitation and other disturbances that affect the measured values, an arrangement directly under the platform also has the disadvantage that too small a part of the aircraft surface, and therefore too small a measuring region, can be seen for a meaningful measurement.

Reference is also made to CN 116 309 468 A, CN 114 924 289 A and US 2023/0099541A 1 . CN 116 309 468 A allows the open/closed status of an aircraft door to be determined without contact.

### SUMMARY

Proceeding from the aforementioned prior art, it is an object of the present disclosure to provide a remedy for the aforementioned disadvantages and, in particular, to provide a method by which the profile and/or position of an outer surface of an aircraft relative to an access or supply device can be reliably determined without the need for a marker on the outer surface of the aircraft. Furthermore, it is an object of the present disclosure to provide a device for determining the profile and/or position of an outer surface of a floating or flying transport relative to an access or supply device, which can be operated with such a method.

This problem is solved by the features specified in the present disclosure.

One embodiment of the present disclosure relates to a method for determining the position and/or profile of an outer surface of an aircraft relative to an access or supply device, wherein a measuring device is arranged on the access or supply device which has:
a transmitting unit for emitting electromagnetic and/or mechanical waves,
a receiving unit for receiving the reflected part of the emitted waves, and
a control unit for controlling and/or regulating the measuring device,
wherein the method comprises the following steps:
defining, by the control unit, a measuring region in which the outer surface is expected to be located or which the outer surface is expected to pass through,
defining at least one reference segment which is located in the measuring region or passes through the measuring region,
emitting the waves by the transmitting unit in such a manner that the waves capture the measuring region,
receiving the reflected part of the emitted waves by the receiving unit,
generating, by the control unit, a point cloud that maps the profile of the outer surface using the received reflected part of the emitted waves,
determining, by the control unit, at least one intersection point where the point cloud and the reference segment intersect, and determining the position of the intersection point.

First, a measuring region is defined. As mentioned at the outset, the present method is mainly useful for determining the position of a transport such as aircraft or ships. If the aircraft in question is in its holding position or the ship in question is moored at the dock, the approximate location of its outer surface is known. Furthermore, the position of the measuring device is also known, which is typically located on the access or supply device. The measuring region can then be defined in such a way that the electromagnetic and/or mechanical waves at least mostly hit the outer surface of the transport and not the ground, the water surface or the access or supply device. It is sufficient to measure only a portion of the outer surface.

A point cloud is generated from the reflected part of the waves, which discretely maps the profile of the outer surface using a plurality of points. According to the present method, it is checked whether the point cloud intersects with at least one previously defined reference segment. If not, the corresponding measurement is discarded. If so, the position of at least one intersection point, where the point cloud and the reference segment intersect, will be determined. The number of aircraft types that can be handled at an access or supply device is usually limited. Furthermore, the aircraft's holding position at the relevant access or supply device is predetermined to ensure that the access or supply device, which has a limited reach, can be moved towards one of the aircraft doors. Therefore, it is at least approximately known to which area of the aircraft fuselage the measured outer surface must belong. Therefore, determining an intersection point between the reference segment and the point cloud can be sufficient to determine the position of the aircraft's outer surface with sufficient accuracy.

The present method requires low computing power, which is why the position of the outer surface of the transport can be determined almost in real time and quasi-continuously. With an increasing number of reference segments and the corresponding number of intersection points, the accuracy of determining the position of the outer surface of the transport increases. Because determining the intersection points requires little computing power, the position of the outer surface can be determined with increased accuracy without the time required becoming disproportionately long.

In the present disclosure, the components typically used in adjustable access or supply devices known from the prior art, namely the autoleveler and the safety shoe, can be omitted, and contactless adjustment can be carried out without the need for marking.

According to a refined embodiment, the reference segment can be a reference line, a reference surface or a reference volume. In principle, the reference segment can be freely defined, as long as an intersection point with the reference segment can be determined. From a geometric and programming perspective, a reference line, a reference surface, or a reference volume is suitable, each of which can be connected and therefore continuous in the mathematical sense.

In a refined embodiment, the reference line can be a straight line, or the reference surface a plane, or the reference volume a cuboid. In all three cases, the reference segment in this embodiment contains no curvature, which keeps the programming and computational effort low.

In a further embodiment of the method, the following step is performed:
generating, by the control unit, a profile surface or profile line from the point cloud which maps the profile of the outer surface.

As mentioned, to determine the position of the outer surface of the transport, at least one intersection point is determined where the point cloud and the reference segment intersect. The determination of the intersection point becomes more accurate if a profile surface or profile line relating to the outer surface of the transport is generated using the points of the point cloud. This can be done using approximation methods. As such, the profile line can be the line to which the points of the point cloud used for the definition have the least distance. A similar approach can be used to define the profile surface. It is not necessary for the profile surface or the profile line to take the entire point cloud into account. Rather, a field of observation can be defined within the measuring region, in which the intersection point should be located with high probability. This can save computational effort.

In a further embodiment, the following steps may be provided:
defining a surrounding area around the reference area, and
defining each of the intersection points by the control unit, using the points of the point cloud located in the surrounding area.

These steps are particularly useful if the reference area is defined by a reference line and no profile surface or profile line is generated from the point cloud to represent the profile of the outer surface. It is relatively unlikely that a point will lie exactly on the reference line. An intersection point can be determined by finding at least one point in the point cloud that lies within the surrounding area. The surrounding area can be defined, for example, with a circle that is moved along the reference segment until at least one point of the point cloud lies within this circle. The position of the center of this circle on the reference segment and especially on the reference line can then be assumed to be the intersection point. This approach also results in low computational effort.

In a refined embodiment, the profile of the outer surface of at least one floating or flying transport is stored in the control unit. Especially in the case of aircraft, the number of aircraft types that can be handled at an access or supply device is limited. Furthermore, the intersection point is found using at least three reference segments, and usually significantly more reference segments, for reasons of redundancy. Since it is also known, at least approximately, which portion of the outer surface is being measured, the determined intersection points can be compared with the stored profiles and the most suitable profile can be identified. Based on the identified profile, the profile of the outer surface outside the measuring region can then also be determined. Furthermore, automatic aircraft type detection is possible. The control unit can send a corresponding proposal to the ground staff or the pilot, requesting confirmation or, if necessary, correction of the proposed aircraft type. Communication can also be established between the control unit and a transponder or other identification unit of the aircraft to automatically verify the aircraft type.

In one embodiment of the present disclosure, the transmitting unit and the receiving unit are not structurally separated from each other, but rather are combined in the same component. In such an embodiment of the present disclosure, the properties of the emitted waves can also be included in the evaluation of the waves with regard to the quantities relating to the spatial distribution of their origin locations and the comparison with the threshold value.

This allows the superposition of emitted and received waves—superimposed interference—to be taken into account for the evaluation.

It is also conceivable, in a further embodiment, to include the proportion of the emitted waves that is scattered in the evaluation and the comparison with the threshold value.

In a particular embodiment, the included quantities may comprise the intensity, phase, frequency and/or signal strength of the emitted waves and/or the reflected part of the emitted waves.

Using suitable modulation and demodulation techniques, in particular but not exclusively with regard to phase, frequency, signal strength or intensity, the relevant properties of the relevant waves can also be evaluated. Position, speed, and other properties of objects can be more easily determined using these quantities. By evaluating these parameters, it is possible, for example, to determine the direction of a target or to analyze movement patterns.

In a further embodiment, the included quantities relating to the spatial distribution of the origin locations may comprise the spatial and/or temporal change in the intensity of the phase, frequency and/or signal strength of the emitted waves and/or the reflected part of the emitted waves.

By evaluating the spatial changes in wave intensity, movements can be detected. If an object moves within the sensor's detection range, the pattern of the received wave intensity changes. This signal can then be used to detect the movement and trigger further actions based on it. By measuring the phase shift between emitted and reflected waves, the distance and exact position of the object can be determined. This enables precise tracking and control of movements. Analyzing the frequency changes of waves allows the measurement of the speed of moving objects. The speed of the object can be determined by evaluating the frequency shift between transmitted and received waves. This is particularly useful for monitoring movements in real time and reacting to them if necessary. For example, if a deviation from a desired position or movement is detected, the sensor system can send corresponding signals to actuators to track the object and restore the desired movement.

In a refined embodiment, in which the access or supply device has a positioning device for changing the position of the access or supply device, the control unit can be used to
define a position difference threshold value with respect to the position of the outer surface,
at a first time point, determine a first position of the intersection point, and at a second time point, determine a second position of the intersection point.
compare the first position with the second position, and determine a difference between the first and second positions and compared these with the position difference threshold value.
activate the positioning device in such a manner that the difference is reduced if it exceeds or falls below the position difference threshold value.

This ensures that adjustment only occurs above a certain predetermined minimum value or within a defined measuring region of minimum and maximum values. By determining the first and second positions of the intersection points at different time points and comparing the difference between these positions with the position difference threshold value, movements or changes of the outer surface can be detected. Activating the positioning device makes it possible to reduce the detected difference and adjust the device to the updated position.

The positioning device within the context of this present disclosure can be, for example, but not exclusively, a hydraulic or electric lifting device. For a hydraulic lifting device, pistons can be extended and retracted when the hydraulic systems are activated.

In a further embodiment, the measuring device can be used to determine the distance between the measuring device and
the ground on which the flying transport is standing, or
the water surface on which the floating transport is floating.

The determination of the distance between the measuring device and the ground or water surface is carried out in largely the same way as described for determining the position of the outer surface of the transport. Therefore, the following steps are taken to determine the ground or water surface:
defining, by the control unit, a further measuring region in which the ground or the water surface is expected to be located or which the ground or the water surface is expected to pass through,
defining, by the control unit, at least one further reference segment which is located in the further measuring region or passes through the measuring region,
emitting the waves by the transmitting unit in such a manner that the waves capture the further measuring region,
receiving the reflected part of the emitted waves by the receiving unit,
generating, by the control unit, a further point cloud that maps the profile of the ground or the water surface using the received reflected part of the emitted waves,
determining, by the control unit, at least one intersection point where the point cloud and the reference segment intersect, and determining the position of the intersection point.

The transmitting unit can be designed to rotate about an axis, in particular a horizontal axis. In addition to the measuring region in which the outer surface of the transport is expected to be located, a further measuring region is defined in which the water surface or the ground is expected to be located. With regard to the further measuring region, at least one further reference area is then defined. However, the distance between the measuring device and the ground or water surface can be determined in the same way as when determining the position of the outer surface relative to the access and supply device.

In the case of an aircraft standing on the ground, the distance between the ground and the measuring device is usually known, so that no determination is necessary. However, determining the distance according to this embodiment of the method can be used to check the functionality of the method. If there is too great a discrepancy between the actual distance and the distance determined by this method, corrective measures can be initiated.

However, the distance between the measuring device and the water surface can vary considerably, especially due to changing water levels and wave action. However, in most ports, water levels are measured automatically, which can be taken into account when determining the distance between the measuring device and the water surface. Consequently, values for the distance can also be determined in this case, which can be compared with those determined using the present method. This means that the functionality of the method can also be checked when using the water surface. Furthermore, in many cases a ground surface can be found in ports which can be used to check the measured distance in a similar way to airports.

In principle, the method can also be used to determine only the distance between the measuring device and the ground or between the measuring device and the water surface, without determining the position of the outer surface of the transport relative to the access or supply device. This can occur during calibration and verification processes.

The measuring device allows the distance between the measuring device and the ground to be measured with high precision. This allows for an accurate determination of the aircraft's height above the ground and thus real-time monitoring of the aircraft's height, which is particularly useful for ground handling. Accurate knowledge of the distance between the aircraft and the ground can also help to avoid collisions or damage. By monitoring and controlling the distance, potential risks can be identified in time and measures can be taken to ensure safety. Monitoring and controlling the distance enables the detection of potential risks and the timely implementation of countermeasures to ensure safety.

One embodiment of the present disclosure relates to an access or supply device for aircraft, comprising a measuring device having:
a transmitting unit for emitting electromagnetic and/or mechanical waves,
a receiving unit for receiving the reflected part of the emitted waves, and
a control unit for controlling and/or regulating the measuring device, wherein
the access or supply device can be operated by a method according to any of the previous embodiments to determine the position and/or profile of an outer surface of an aircraft relative to the access or supply device.

The technical effects and aspects that can be achieved with the proposed device correspond to those that have been discussed for the present method.

An advanced embodiment can specify that the access or supply device comprises a weather protection unit to reduce the influence of weather conditions on determining the position and/or profile of the outer surface.

Rain, snow, ice, fog, strong winds or other weather phenomena could affect the accuracy of the measurements. The weather protection unit ensures that these influences are reduced or eliminated. This helps to avoid possible damage or malfunctions of the measuring device caused by external influences. Unwanted reflections or scattering of the emitted waves due to weather conditions are minimized. This allows for higher accuracy and consistency of the measurements. The weather protection unit extends the operating time of the measuring device and enables continuous measurements regardless of prevailing weather conditions.

According to an advanced embodiment, the weather protection unit can be formed by the access or supply device itself.

Integrating the weather protection unit into the access or supply device creates a cohesive and integrated design. This reduces the need for separate components or additional assembly, resulting in simpler installation and a more compact overall system. Both functions, access and weather protection, can be combined in a single component. This saves space and weight, and, combined with reduced installation and integration effort, also costs. Maintenance and repairs are also made easier. Since both functions are combined in a single component, fewer separate components are affected in the event of a malfunction, which simplifies maintenance work.

In an advanced embodiment, the access or supply device can have a projection with a free end, the free end pointing towards the aircraft in its intended use position and the measuring device being arranged below the projection.

Access to the measuring device is made easier. Furthermore, by positioning the measuring device below the projection, the probability of unwanted reflections of the emitted waves is reduced. Projecting from the access or supply device, the projection can itself be the weather protection unit, and thus also serve to protect the measuring device from direct environmental influences.

A more advanced embodiment can specify that the measuring device is attached to the projection using a spacer.

By using a spacer, the exact measuring distance between the measuring device and the outer surface of the aircraft can be precisely set. This improves measurement accuracy, as the optimal distance for capturing the reflected waves is maintained. The spacer can help to dampen or isolate vibrations or disturbances that might come from the access or supply device or other sources, thus contributing to the stability of the measuring device and therefore the measurements. A spacer also allows for flexible and adaptable installation of the measuring device. Depending on the specific requirements and circumstances, different spacers can be used to achieve the optimal positioning and alignment of the measuring device.

### BRIEF DESCRIPTION OF THE DRAWINGS

Exemplary embodiments of the present disclosure are explained in more detail below with reference to the accompanying drawings, wherein:

FIG. 1 shows an exemplary embodiment of an access device according to the present disclosure, which is in contact with a fuselage of a transport, wherein the fuselage is in a first position, illustrated by a basic sectional view.

FIG. 2 shows the exemplary embodiment shown in FIG. 1, wherein the fuselage is in a second position, illustrated by a basic sectional view.

FIG. 3 shows the exemplary embodiment shown in FIG. 1, wherein the fuselage is in a third position, illustrated by a basic sectional view.

FIG. 4 is an enlarged illustration of detail A defined in FIG. 3.

FIG. 5 shows an alternative illustration with an additional weather protection unit as a separate component.

FIG. 6a shows a first graphical illustration to explain the method according to the present disclosure,

FIG. 6b shows a second graphical illustration to explain the method according to the present disclosure,

FIG. 6c shows a third graphical illustration to illustrate the method according to the present disclosure, and

FIG. 7 shows a flowchart of a method according to the present disclosure for determining the position and/or profile of an outer surface of an aircraft relative to an access or supply device.

### DETAILED DESCRIPTION

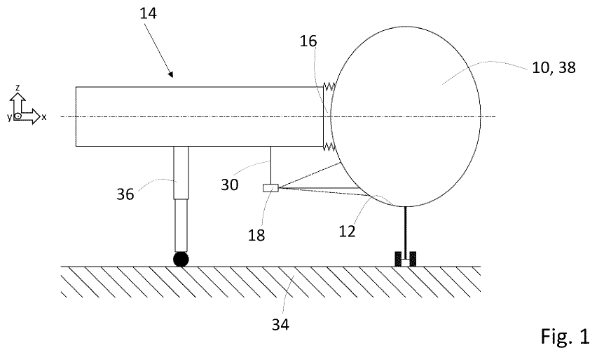

FIG. 1 shows an exemplary embodiment of an access device 14 according to the present disclosure, which is in contact with a transport 38, for example a fuselage of an aircraft 10, in particular with the outer surface 12 of the aircraft 10. The fuselage of the aircraft 10 is in a first position, for example in a parking or handling position, in which the aircraft 10 is standing on a ground, in particular on an apron.

The access device 14 is designed to provide safe and convenient access to the aircraft 10 for personnel or passengers. In the exemplary embodiment shown in FIG. 1, the access device 14 is illustrated as a separate component that is brought into contact with the fuselage of the aircraft 10. In this first position of the aircraft fuselage, the aircraft 10 is ready for handling operations such as the boarding or disembarking of passengers, catering, refueling, or the loading and unloading of cargo. In addition to the access device 14 with a folding canopy 16, a measuring device 18 arranged under the access device 14 itself is also shown, which is connected to the access device 14 by a spacer 30. The measuring device 18 precisely captures the outer surface 12 of the aircraft fuselage with a certain number of vectors, the length and angle of which are fixed in a coordinate system as a point cloud of the first position.

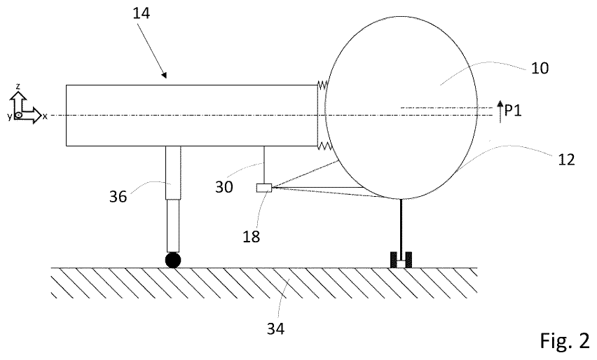

In FIG. 2, the aircraft 10 is in a second position in which the aircraft fuselage has been elevated relative to the first position, for example as a result of an unloading process. The elevation is symbolized by the arrow P1 in FIG. 2. This causes various distances between the measuring device 18 and measured points on the outer surface 12 to change in such a way that the reflected part of the electromagnetic or mechanical waves in the coordinate system generates a point cloud that differs from the point cloud of the first position.

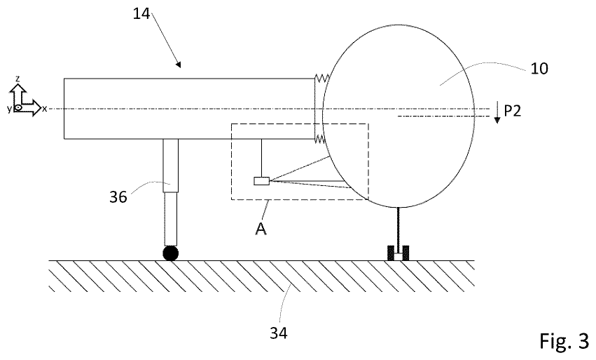

FIG. 3 illustrates the lowering of the aircraft fuselage, during which the measuring device 18 registers a position closer to the ground 34 as a result of the loading of the aircraft 10. The lowering process is graphically represented by the arrow P2. Here too, various distances between the measuring device 18 and measured points on the outer surface 12 change.

During both the elevating and lowering processes, the position of the access device 14 must be adjusted beyond a certain value, for example hydraulically or electrically by a positioning device 36.

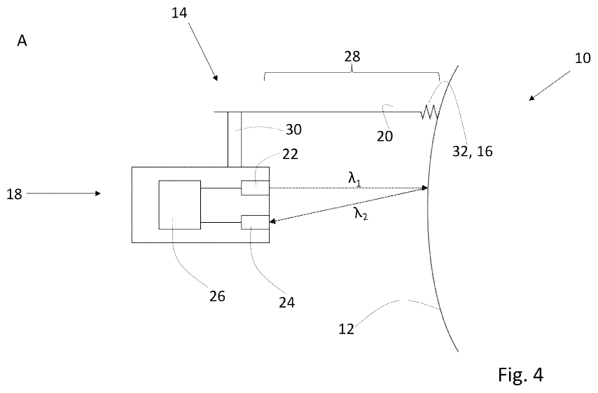

FIG. 4 shows detail A, which demonstrates aspects of the measuring device 18.

The outer surface 12 shown here also refers to the outer shell or area of the aircraft 10 which the access or supply device 14 sees or approaches. The measuring device 18 comprises various components such as a transmitting unit 22, a receiving unit 24 and an electronic control unit 26. The measuring device 18 captures information about the position or profile/course of the outer surface 12 of the aircraft.

The transmitting unit 22 emits electromagnetic or mechanical waves λ₁ which are at least partially reflected by the outer surface 12 of the aircraft 10. The receiving unit 24 receives the reflected part λ₂ of the emitted waves. The control unit 26 controls and regulates the measuring device 18 and enables the analysis of the reflections. It can define an intensity threshold related to the reflected part λ_{2,} and determine the position of the outer surface 12.

The embodiment shown in FIG. 4 also shows a weather protection unit 20, which protects the measuring device 18 from weather influences. The measuring device 18 is arranged under a projection 28, which has a free end 32 in the area of the folding canopy 16, pointing towards the aircraft 10. The projection 28 is formed by a part of the access or supply device 14 that, in this case, extends beyond the positioning device 36 to the free end 32. The spacer 30 serves to attach the measuring device 18 to the projection 28 of the access or supply device 14.

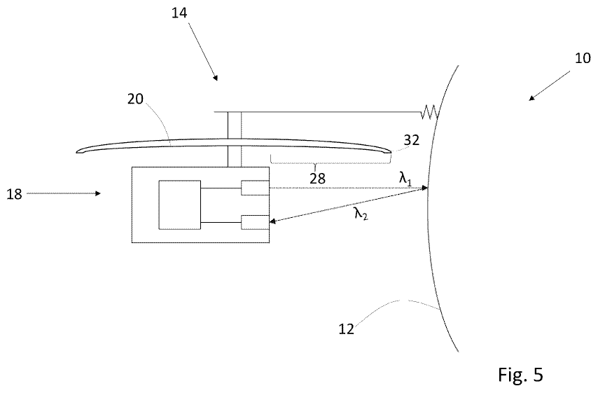

In a further exemplary embodiment, shown in FIG. 5, the weather protection unit 20 is not formed by the access or supply device 14 itself. Instead, a separate component is used for this purpose, so that the measuring device 18 is protected from external influences by the weather protection unit 20 and its projection 28, which, in embodiments, is located close to the measuring device 18.

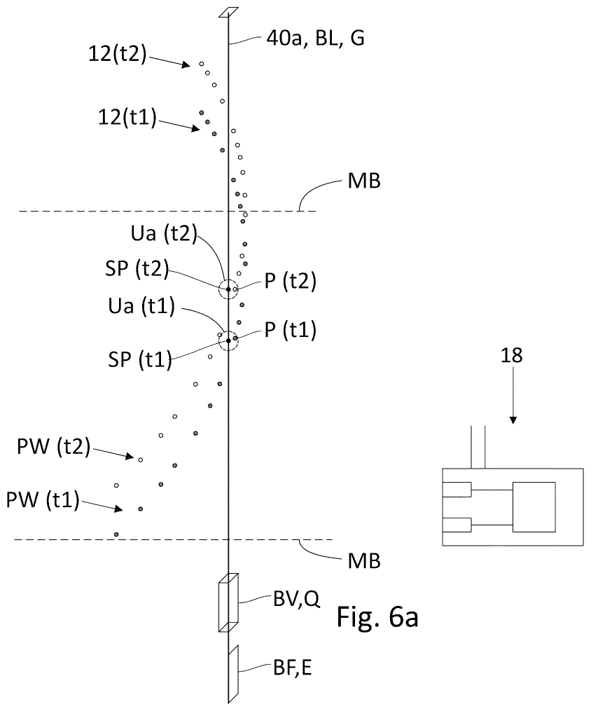

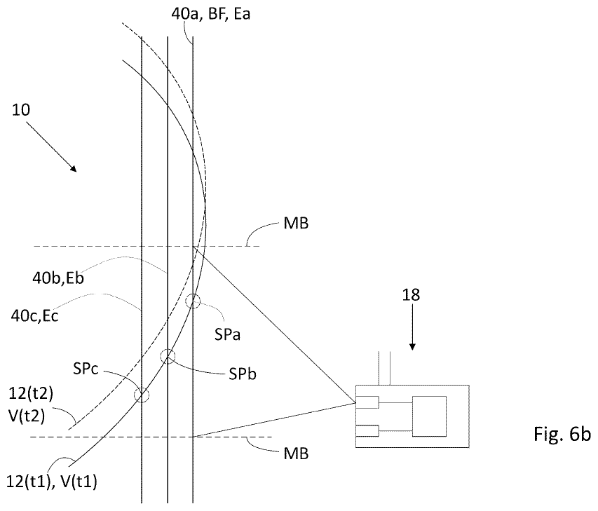

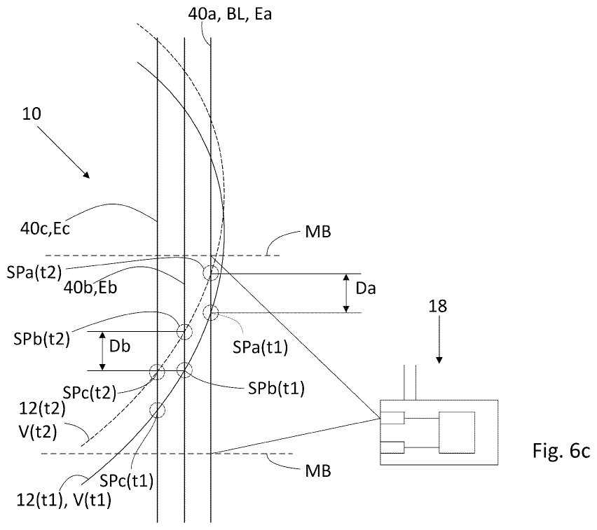

FIG. 6a shows details of the method according to the present disclosure for determining the position of an outer surface 12 of a transport 38 (see also in particular FIGS. 1 to 3). The transport 38, of which the position of its outer surface 12 is to be determined, is in a holding position (aircraft) or is attached to the berth (ship), so that the access or supply device 14 can be moved up to the transport 38.

First, a measuring region MB is defined in which the outer surface 12 of the transport 38 is expected to be located. Furthermore, a reference segment 40a is defined which is located in the measuring region MB or, as shown in FIG. 6a, passes through the measuring region MB. In embodiments, the reference segment 40a to be limited by the measuring region MB and consequently not to extend beyond it. In the illustrated exemplary embodiment, the reference segment 40a is defined by reference line BL, which is a straight line G. FIG. 6a also shows, to illustrate further exemplary embodiments, a reference surface BF and a reference volume BV with which the reference segment 40a can be defined. The reference surface BF is a plane E and the reference volume BV is a cuboid Q. In these definitions, the reference segment 40a does not exhibit any curvature, which is not necessarily the case.

The waves λ₁ (FIG. 4) are emitted by the measuring device 18 in such a way that they completely cover the measuring region MB and hit the outer surface 12 of the transport 38. The reflected part λ₂ of the emitted waves is received by the receiving unit 34 and evaluated by the measuring device 18 in such a way that a point cloud PW is generated. As can be seen from FIG. 6a, the point cloud PW discretely maps the profile of the outer surface 12 using a plurality of points P.

In addition, a surrounding area U is defined, for example using a circle. The circle is moved along the reference line BL until at least one point P of the point cloud PW lies inside the circle. This point P is the one that has the smallest distance to the reference line BL. If multiple points P lie within the circle, the distance of these circles to the reference line BL can be measured and the point P with the least distance to the reference line BL can be identified. The position on the reference line BL and the radius of the circle can be changed until only the point P with the least distance to the reference line BL lies in the circle.

The position of the center point of this circle on the reference line BL can then be assumed to be the position of an intersection point SP (not shown) where the point cloud and the reference line BL intersect. Other methods for determining the position of the intersection point SP are also conceivable.

This method is repeated at regular intervals. Depending on the available computing power, the time intervals can be very small, so that the position of the intersection points SP can be determined quasi-continuously. In FIG. 6a, the position of a first intersection point SP(t1) at a first time point and of a second intersection point SP(t2) at a second time point has been determined. Between the first time point and the second time point, the position of the outer surface 12 of the transport 38 has changed, so that the positions of the first intersection point SP(t1) and the second intersection point SP(t2) differ from each other, with both intersection points SP(t1) and SP(t2) lying on the reference line. This will be discussed in more detail later.

FIG. 6b shows the same as FIG. 6a; however, a profile line V has been generated from the point cloud PW, so that the profile of the outer surface 12 of the transport 38 is now illustrated as a continuous profile. A first profile V(t1) at the first time point and a second profile V(t2) at the second time point are shown.

In addition, a total of three reference segments 40a, 40b, 40c are used, each of which is designed as reference surfaces BF in the form of a first plane Ea, a second plane Eb and a third plane Ec. Therefore, a primary intersection point SPa with the first plane Ea, a secondary intersection point SPb with the second plane Eb, and a tertiary intersection point SPc with the third plane Ec can be defined. FIG. 6b shows the primary intersection point SP, the secondary intersection point SP and the tertiary intersection point SP at the first time point.

As mentioned, in FIG. 6b a first profile V(t1) was determined at the first time point and a second profile V(t2) at the second time point. FIG. 6c shows, in addition to the primary intersection point SPa(t1), the secondary intersection point SPb(t1) and the tertiary intersection point SPc(t1) at the first time point, the primary intersection point SPa(t2), the secondary intersection point SPb(t2) and the tertiary intersection point SPc(t2) at the second time point. Furthermore, a first difference Da between the primary intersection point SPa(t1), SPa(t2) at the first time point and at the second time point on the first plane Ea and a second difference Db between the secondary intersection point SPb(t1), SPb(t2) at the first time point and at the second time point on the second plane Eb are shown. A corresponding third difference Dc on the third plane Ec is not shown for presentation reasons. The differences D are differences in the positions of the mentioned intersection points SP on the respective planes E and thus distances.

The first plane Ea, the second plane Eb and the third plane Ec run parallel to each other and perpendicular to the ground 34 (see FIG. 1 to 3). Typically, the position of the transport 38 also changes perpendicular to the ground 34, so that the transport 38 performs a purely translational movement. With uneven loading, it can happen that the position changes only on one side or changes more on one side than on the other, resulting in a rotational movement. While in a purely translational movement, as shown in FIGS. 6a to 6c, the first difference Da and the second difference Db are the same, this can be different in a rotational movement; however, this almost never occurs in aircraft. However, this may be different for ships. In this case, adjustment can be made in the x, y and z directions.

It is assumed in the following that the first difference Da and the second difference Db are the same when there is a change in position. Accordingly, the control unit 26 can process multiple differences D and check them for plausibility without having to make any corrections, especially depending on the planes E on which the differences D lie. Implausible differences D can be ignored, and an average can be taken from the remaining differences D. This difference D can then be compared with a position difference threshold value. In the event that the difference exceeds or drops below the position difference threshold value, the positioning device 36 can be activated in such a way that the difference D is reduced.

Not shown is an exemplary embodiment of the present method in which, in addition to determining the position of the outer surface of the transport relative to the access or supply device, the distance between the measuring device and the water surface or between the measuring device and the ground is also determined. The distance is determined substantially in the same way as the position of the outer surface. However, a further measuring region is determined, in which the ground or water surface is expected to be located or which the ground or water surface will pass through. In addition, at least one further reference segment is defined, which is located in the wider measuring region or which passes through the wider measuring region. The measuring device is designed in such a way that the waves emitted by the transmitting unit not only cover the measuring region, but also the wider measuring region. This can be achieved, for example, by rotating the transmitting unit about a horizontal axis. The evaluation of the part of the emitted waves reflected from the water surface or the ground is done in the same way as the position of the outer surface is determined.

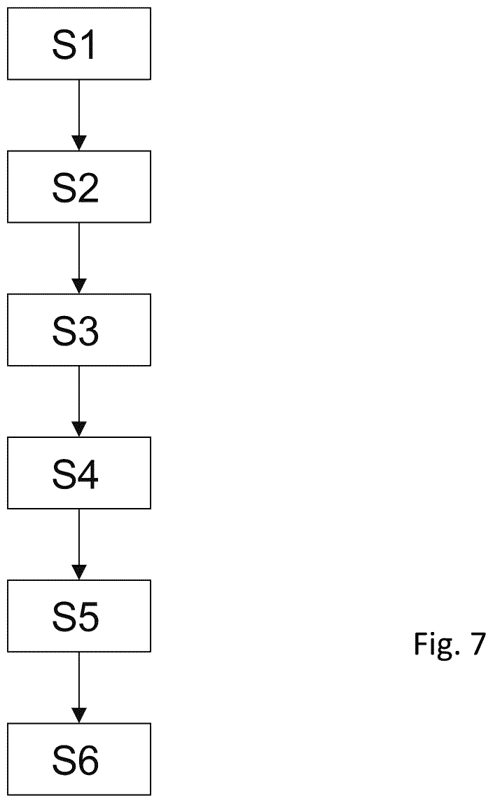

FIG. 7 graphically illustrates the work steps necessary for carrying out the method according to the present disclosure using the measuring device 18, for one embodiment.
S1: Defining a measuring region MB in which the outer surface 12 is expected to be located or which the outer surface 12 is expected to pass through.
S2: Defining at least one reference segment 40a, 40b, 40c which is located in the measuring region MB or passes through the measuring region MB.
S3: Emitting the waves λ₁ by the transmitting unit 22 in such a manner that the waves λ₁ capture the measuring region MB,
S4: Receiving the reflected part λ₂ of the emitted waves λ₁ by the receiving unit 24,
S5: Generating, by the control unit, a point cloud that maps the profile of the outer surface 12 using the received reflected part λ₂ of the emitted waves λ₁,
S6: Determining, by the control unit, at least one intersection point where the point cloud and the reference segment 40a, 40b, 40c intersect, and determining the position of the intersection point.

### LIST OF REFERENCE SIGNS

10 aircraft
11
12 outer surface
13
14 access or supply device
16 folding canopy
17
18 measuring device
19
20 weather protection unit
21
22 transmitting unit
23
24 receiving unit
26 control unit
27
28 projection
29
30 spacer
31
32 free end
33
34 ground
35
36 positioning device
38 transport
40a, 40b, 40c reference segment
BF reference surface
BL reference line
BV reference volume
D difference
G straight line
E plane
MB measuring region
P points on point cloud
PW point cloud
Q cuboid
SP intersection point
U surrounding area
V profile line
λ₁ electromagnetic or mechanical waves
λ₂ reflected part

1. A method for determining a position of an outer surface of a floating transport or a flying transport relative to an access or supply device, wherein a measuring device is arranged on the access or supply device, the measuring device comprising:
a transmitting unit configured to emit electromagnetic and/or mechanical waves,
a receiving unit configured to receive a reflected part of the emitted waves (λ₁), and
a control unit configured to control and/or regulate the measuring device,
wherein the method comprises:
defining, the control unit, a measuring region in which the outer surface is expected to be located or which the outer surface is expected to pass through,
defining, by the control unit, at least one reference segment which is located in the measuring region or passes through the measuring region,
emitting the waves by the transmitting unit in such a manner that the waves capture the measuring region,
receiving the reflected part of the emitted waves by the receiving unit,
generating, by the control unit, a point cloud that maps a profile of the outer surface using the received reflected part of the emitted waves,
determining, by the control unit, at least one intersection point where the point cloud and the at least one reference segment intersect, and determining a position of the at least one intersection point.

2. The method according to claim 1, wherein the at least one reference segment is a reference line, a reference surface, or a reference volume.

3. The method according to claim 2, wherein:
the reference line is a straight line, or
the reference surface is a plane, or
the reference volume is a cuboid.

4. The method according to claim 1 further comprising:
generating, by the control unit, a profile surface or profile line from the point cloud which maps the profile of the outer surface.

5. The method according to claim 1 further comprising:
defining a surrounding area around the at least one reference segment, and
defining the intersection point by the control unit using points of the point cloud located in the surrounding area.

6. The method according to claim 1, wherein the profile of the outer surface of at least one floating transport or flying transport is stored in the control unit.

7. The method according to claim 1, wherein the emitted waves are included in an evaluation regarding quantities relating to spatial distribution of origin locations.

8. The method according to claim 7, wherein the quantities relating to the spatial distribution of the origin locations comprise an intensity, a phase, a frequency and/or a signal strength of the emitted waves and/or the reflected part of the emitted waves.

9. The method according to claim 1,
wherein the access or supply device has a positioning device for changing a position of the access or supply device,
wherein a position difference threshold value is defined, by the control unit, with respect to the position of the outer surface,
wherein a first position of the intersection point is determined, by the control unit, at a first time point,
wherein a second position of the intersection point is determined, by the control unit, at a second time point,
wherein the first position is compared with the second position, by the control unit,
wherein a difference between the first position and the second position is determined and compared, by the control unit, with the position difference threshold value, and
in an event that the difference exceeds or drops below the position difference threshold value, the positioning device is activated, by the control unit, in such a way that the difference is reduced.

10. The method according to claim 1, wherein the measuring device determines a distance between the measuring device and a ground on which the flying transport is located or a water surface on which the floating transport is floating.

11. An access or supply device for a floating transport or a flying transport, comprising a measuring device having:
a transmitting unit configured to emit electromagnetic and/or mechanical waves,
a receiving unit configured to receive a reflected part of the emitted waves, and
a control unit configured to control and/or regulate the measuring device,
wherein the access or supply device is configured to be operated by the method according to claim 1 for determining the profile and/or position of an outer surface of the floating transport or the flying transport relative to the access or supply device.

12. The access or supply device according to claim 11 further comprising a weather protection unit for reducing an influence of weather conditions on determining the position and/or profile of the outer surface.

13. The access or supply device according to claim 12, wherein the weather protection unit is formed by the access or supply device itself.

14. The access or supply device according to claim 13, wherein access or supply device has a projection with a free end, wherein the free end points towards the floating transport or flying transport in its intended use position, and the measuring device is arranged below the projection.

15. The access or supply device according to claim 14, wherein the measuring device is attached to the projection by a spacer.
